(19) United States
(12) Patent Application Publication
(10) Pub. No.: US 2008/0040405 A1
(43) Pub. Date: Feb. 14, 2008

(54) SYSTEM AND METHOD FOR MANAGING ADDITIONAL INFORMATION OF MP3 MUSIC FILE STORED IN MEDIA PLAYER

(75) Inventors: Ho-Won Jung, Suwon-si (KR); Hyun-Sup Yun, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/835,498

(22) Filed: Aug. 8, 2007

(30) Foreign Application Priority Data
Aug. 8, 2006 (KR) 2006-74754

(51) Int. Cl. G06F 17/30

(52) U.S. Cl. 707/205; 707/E17.005

(57) ABSTRACT

A management system and method for managing additional information of MP3 music files stored in a media player terminal are disclosed. In correcting the tag information of a media file, all media file data are not transmitted between a PC and a media player terminal. The media player terminal transmits only a corresponding music file list and the tag information rather than the corresponding music files, and the PC can change and manage the tag information based on the music file list and the tag information received from the media player terminal.

### PRIORITY

This application claims priority under 35 U.S.C. §119(a) to a Korean Patent Application entitled “SYSTEM AND METHOD FOR MANAGING ADDITIONAL INFORMATION OF MP3 MUSIC FILE STORED IN MEDIA PLAYER” filed in the Korean Intellectual Property Office on Aug. 8, 2006 and assigned Serial No. 2006-74754, the contents of which are incorporated herein by reference.

### BACKGROUND OF THE INVENTION

1. Field of the Invention

The present invention relates generally to a system and method for managing media files stored in a media player, and in particular, to a system and method for managing additional information of MP3 music files stored in a media player terminal.

2. Description of the Related Art

The term MP3 refers to MPEG Layer 3 according to MPEG audio technologies. An MP3 program can compress audio data into an audio packet having a size of about 1/12 of the original data without having to degrade the quality of the data, and thus is adequate to transmit audio files along transmission lines of a limited transmission capacitance. This consequently makes the MP3 program more popular among Internet users who enjoy music. In particular, a user can convert his/her favorite music into MP3 files to edit music albums in a PC by using the MP3 program, and can utilize the PC as an audio system by using a program capable of playing the MP3 files. Generally, users listen to MP3 music by connecting an earphone to a portable MP3 player or from a computer equipped with a sound card and a speaker.

As a result of the commercialization of media player terminals supporting a large capacity memory such as an MP3 player, Portable Multimedia Player (PMP) and mobile phone capable of playing MP3 files, various approaches for managing music files are under development. Some of the media player terminals provide a solution for managing music files by using ID-3 tag information of media files such as MP3, MP4, Advanced Audio Coding (AAC) and so on. An ID-3 tag means an additional information record of an MP3 file, and is used as information by which the MP3 file can be searched for. Such ID-3 tags can be searched by sorting music or multimedia files according to ID-3 tag information such as album, artist and genre. For example, when a user accesses a menu for file play in the media player terminal, the file play menu consists of sub-menus according to album, artist, genre, and so on. In each of the sub-menus, all of the stored music is indexed according to album, artist, genre, and so on. The user can then select one of them. If the user selects “album” in the sub-menus, albums of all music files stored are listed.

In music files, additional information or data are managed by ID-3 tags. As shown in FIG. 1A, the ID-3 tags can be made directly by a file manufacturer or in a PC using a player program, and then transmitted to the media player to be used. In order to change the data in an ID-3 tag, it is possible to change the ID-3 tag of a media file in a PC 110 in step 102 and provide the media file including the changed ID-3 tag to a media player terminal 100 at step 104. Then, the media player terminal 100 generates and stores an ID-3 tag list. As further shown in FIG. 1B, when the media player terminal 100 transmits a file at step 112, the PC 110 changes an ID-3 tag in the media file at step 114, and then provides the media file including the changed ID-3 tag to the media player terminal 100 at step 116. The media player terminal 100 then generates and stores an ID-3 tag list at step 118.

Thus, in order to change the ID-3 tag information of a media file stored in the media player terminal, it is required to directly correct the ID-3 tag information in a specific device, such as a PC capable of changing the ID-3 tag information, and then transmit the changed information to the media player terminal, or transmit the media file to the PC to be corrected and then transmit the corrected media file to the media player terminal again. As the ID-3 tag information should be corrected in the external device such as a PC, the file itself should be transmitted even though only the ID-3 tag information is to be changed. This subsequently causes unnecessary data transmission. Transmitting a large number of files for the correction of their ID-3 tag information may consume a large amount of time as a drawback.

### SUMMARY OF THE INVENTION

Accordingly, the present invention has been made to solve the above-mentioned problems occurring in the prior art, and the present invention provides a system and method for managing additional information of media files stored in a media player terminal, in which all media file data are not necessarily transmitted but only the media file list and the tag information necessary for the tag information correction are transmitted when the tag information of the media file is corrected.

According to one aspect of the present invention, there is provided a management system including a media player terminal storing tag information of media files. The system includes the media player terminal generating, in response to a request message for a media file list, the media file list and transmitting the generated media file list together with the tag information of the media files, and changing, in response to a correction request message, existing tag information of a corresponding one of the media files into requested tag information; and an external device for sending, in response to an input for tag correction, the media file list request message to the media player terminal upon receiving the media file list, displaying the received media file list on a screen, displaying in response to a user selecting the corresponding media file to correct, the existing tag information of the selected media file, and sending, in response to the user correcting the existing tag information of the selected media file, the correction request message to the media player terminal to correct the existing tag information of the selected media file.

According to another aspect of the present invention, there is provided a management method in a system including a media player terminal and an external device with a communication connection established therebetween, in which the media terminal stores tag information of media files. The method includes, at the external device, sending a media file list request message to the media player terminal in response to an input for tag correction; at the media player terminal, generating the media file list and transmitting the generated media file list together with the tag information of the media files in response to the media file list request message; at the external device, displaying, upon receiving the media file list, the received media file list on a screen, displaying, in response to a user selecting at least one of the media files to correct, the existing tag information of the selected media file, and sending, in response to the user correcting the existing tag information of the selected media file, the correction request message to the media player terminal to correct the existing tag information of the selected media file into requested tag information; and at the media player terminal, changing the existing tag information of the selected media file into the requested tag information in response to the correction request message.

### BRIEF DESCRIPTION OF THE DRAWINGS

The above and other objects, features and advantages of the present invention will be more apparent from the following detailed description taken in conjunction with the accompanying drawings, in which:

FIGS. 1A and 1B are signal flow diagrams illustrating a management process of the ID-3 tag information of a conventional MP3 music file;

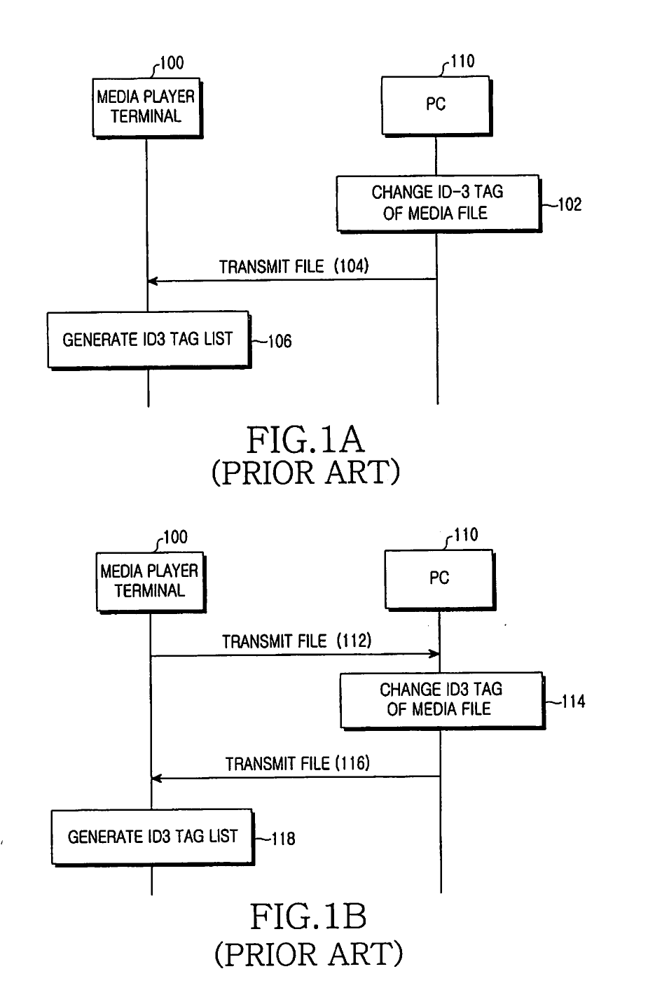

FIG. 2 is a block diagram illustrating a system layout including a media player terminal and a remote unit for managing the ID-3 tag information of MP3 music files stored in the media player terminal according to an exemplary embodiment of the invention;

FIG. 3 is a flow diagram illustrating signal flows between the media player terminal and the remote unit for managing the ID-3 tag information of MP3 music files stored in the media player terminal according to an exemplary embodiment of the invention; and

FIGS. 4A and 4B illustrate exemplary screens of the remote unit and the media player terminal during the ID-3 tag information management of MP3 music files according to an exemplary embodiment of the invention.

### DETAILED DESCRIPTION OF THE PREFERRED EMBODIMENTS

Preferred embodiments of the present invention will be described in detail herein below with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

The present invention provides a solution to efficiently correct the ID-3 tag information of the MP3 music files stored in a media player terminal by which the media player terminal transmits only a corresponding music file list and the ID-3 tag information rather than the corresponding music files, and a remote unit (or external device) can receive the music file list and the ID-3 tag information to change and manage the ID-3 tag information.

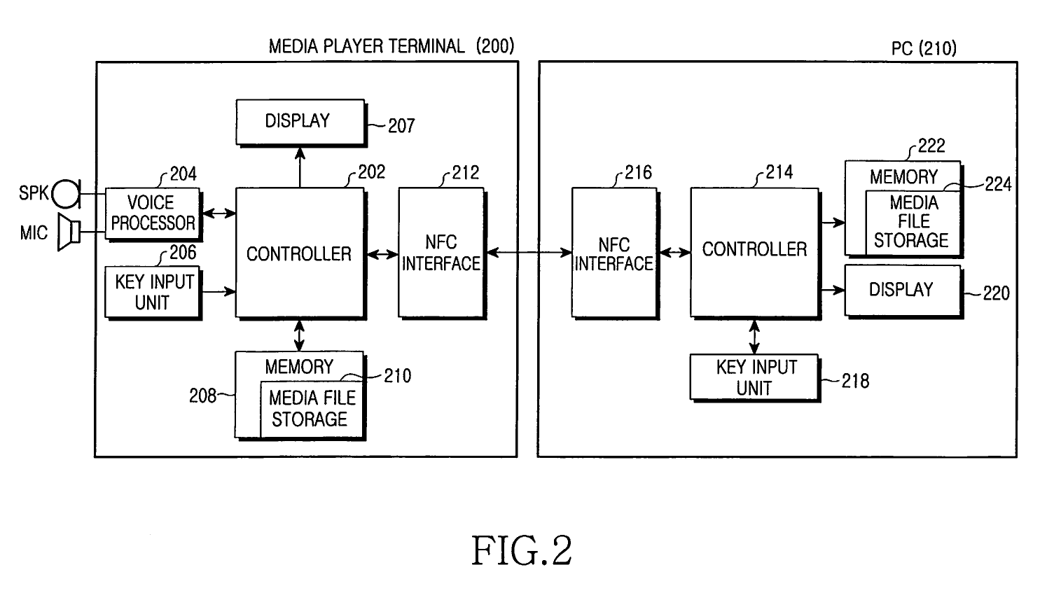

In FIG. 2, the detailed structure of a media player terminal 200 and a remote unit such as a PC 210 according to an exemplary embodiment of the invention is illustrated, in which the ID-3 tag information of the MP3 music files stored in the media player terminal is remotely corrected by the PC 210.

In FIG. 2, the media player terminal 200 includes a controller 202, a voice processor 204, a key input unit 206, a display unit 207, a memory 208 having a media file storage 210, and a Near Field Communication (NFC) interface 212.

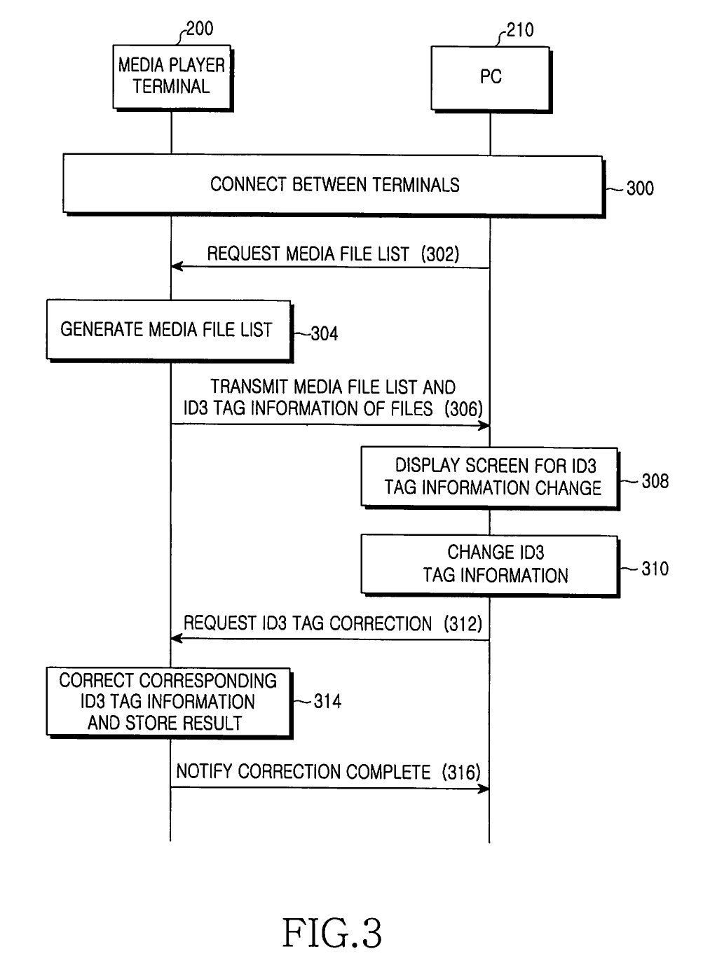

First, the controller 202 controls overall operations for media play and management. In particular, the controller 202 generates a media file list including names of media files stored in the media file storage 210 when receiving a media file request message via the NFC interface 212. Then, the controller 202 reads the ID-3 tag information on the media files together with the generated media file list from the media file storage 210 and outwardly transmits the ID-3 tag information and the media file list to the PC 210 via the NFC interface 212. Upon receiving an ID-3 tag correction request message from the NFC interface 212, the controller 202 discerns the ID-3 tag information of a corresponding file and changes the ID-3 tag information of the corresponding file into new ID-3 tag information contained in the correction request message. The detailed operation of the controller 130 according to this embodiment will be described below with reference to FIG. 3.

The key input unit 206 has a plurality of number keys and function keys, and outputs key input data to the controller 202 in response to keys pressed by the user.

The display unit 207 displays various messages under the control of the controller 202. The display unit 207 may be implemented with a Liquid Crystal Display (LCD), a Thin Film Transistor (TFT), an organic Electro-Luminescence (EL) and the like.

The memory 208 connected with the controller 202 may be a Read Only Memory (ROM), a Random Access Memory (RAM), and so on, for storing a plurality of programs and information necessary for controlled operation of a mobile communication terminal. In particular, the memory 208 stores programs enabling the controller 202 to execute operations according to the invention as described above, and includes the media file storage 210. In the present invention, the media file storage 210 stores media files, a media file list including names, sizes, types and date information of the media files, and the ID-3 tag information of the media files. However, it should be understood that not all of the media files have the ID-3 tag information.

The NFC interface 212 is an interface for communicating with the PC 210, and may be implemented with a communication interface for communicating with an external unit via Universal Serial Bus (USB), British Telecommunications (BT), Infrared Data Association (IrDA) and so on.

A description will now be given of the internal structure of the PC 210 for receiving a media file list and the ID-3 tag information of files from the media replay terminal 200 to correct the existing ID-3 tag information. While this embodiment has been described with respect to the PC as an example of a remote unit for correcting the ID-3 tag information of the media files, other units of an easy input function, such as a pocket PC and palm PC, can also be used.

Furthermore, in FIG. 2, the PC 210 includes a controller 214, an NFC interface 216, a key input unit 218, a memory 222 and a display unit 220.

The controller 214 controls overall operations of the PC 210. In particular, upon receiving a user input requesting the ID-3 tag correction, the controller 214 of this embodiment transmits a media file list request message to the media play terminal 200 via the NFC interface 216 to request a media file list therefrom. When receiving the ID-3 tag information of the files together with the media file list via the NFC interface 216, the controller 214 then outputs the media file list via the display unit 220. When the user selects a file to be corrected, the controller 24 directs the display unit 220 to display a correction screen where ID-3 tag information of the selected file can be corrected. When the user corrects the ID-3 tag information of the selected file, the controller 214 transmits an ID-3 tag correction request message to the media player terminal 200 via the NFC interface 216 to request the terminal 200 to correct the ID-3 tag information of the selected file. Here, the ID-3 tag correction request message may be generated to include only the corrected ID-3 tag information of the selected file instead of the ID-3 tag information of all files received from the media player terminal 200.

The NFC interface 216 is an interface for communication with the media player terminal 200, and may be implemented with a communication interface for communicating with an external unit via USB, British Telecommunications (BT), IrDA and so on.

The key input unit 218 has a plurality of number keys and function keys, and outputs key input data to the controller 214 in response to keys pressed by the user.

The display unit 220 displays various messages under the control of the controller 214. The display unit 220 may be implemented with an LCD, a TFT, an organic EL, and so on.

The memory 222 connected with the controller 214 includes a ROM, a RAM, and so on, for storing a plurality of programs and information necessary for controlled operation of a mobile communication terminal. In particular, the memory 222 stores media display programs 224 enabling the controller 214 to execute operations according to the invention as described above.

The signal flows between the media player terminal 200, as illustrated in FIG. 2 and the PC 210, and operations in the media player terminal 200 and the PC 210 will now be described with reference to FIG. 3. In this case, messages transmitted between the media player terminal 200 and the PC 210 can be used by adding or expanding messages provided by the invention into AT-Command messages or Obex protocol, which is used in common serial communication.

First, it is assumed that the media player terminal 200 is connected with the PC 210 at step 300. Then, in response to a user input requesting the PC 210 to correct the ID-3 tag information of a media file, the PC 210 transmits a media file list request message to the media player terminal 200 in step 302. The media file list request message transmitted from the PC 210 to the media player terminal 200 may be for example “Get Mediafile_list.” Such a file list request message may be composed as in Table 1 below:

TABLE 1

| | Command | HdrName (Path of a directory storing |
|---|---|---|
| Command | Type | contents information to be obtained) |
| CMD_GET | fs/file_listing | /Media/Music/CHANG Yun-Jeong |

Upon receiving the file list request message, the media player terminal 200 generates a media file list. The media file list includes names, sizes, types and corrected dates of media files. As the media file list is generated, the media player terminal 200 transmits the media file list together with the ID-3 tag information of the files to the PC 210 at step 306. The media file list and the ID-3 tag information of the files may be transmitted on, for example, a “Resp Mediafile_list” message. This message including media file list and the ID-3 tag information of the files may be composed as in Table 2 below:

TABLE 2

| Command Type | Body (Contents list) |
|---|---|
| fs/file_listing | <FileName>, <FileSize>, <Attribute>, <ModifyDate>, |
| | <ID3Tag> list |

In this case, an ID-3 tag may be composed as in Table 3 below, in which the constitution of the ID-3 tag will be discussed with respect to the ID-3 tag v1.

TABLE 3

| Tag type | Remarks |
|---|---|
| 01 | Title |
| 02 | Artist |
| 03 | Album |
| 04 | Year |
| 05 | Comment |
| 06 | Genre |
| 07 | Track Number |

In the message including the media file list and the ID-3 tag information of the files, a character string of two digits indicates the number of bodies, and the bodies follow the character string. Each of the bodies may have a format of, for example, “[tag type (2 digit fixed)][body length (3 digit fixed)][body contents (variable)],” in which the tag type and body length are fixed in two and three digit characters but the body contents have a variable length. That is, an ID-3 tag has a structure as shown in Table 4 below. In addition, an example of a message including a media file list and ID-3 tag information of media files may be composed in Unicode as shown in Table 5 below:

TABLE 4

[Number of bodies (2 digits)]
[Tag type (2 digits)][Body length (3 digits)][Body Contents]
[Tag type (2 digits)][Body length (3 digits)][Body Contents]...

TABLE 5

“test.mp3”,83423,111110000,2004;03:01
01:03:00,0201009TestTitle02006Artist<CR><LF>
“test2.mp3”,245623,111010100;2006:02:10
12:10:00,0302003 [symbol] 030043 [symbol] 06002 [symbol]
<CR><LF>

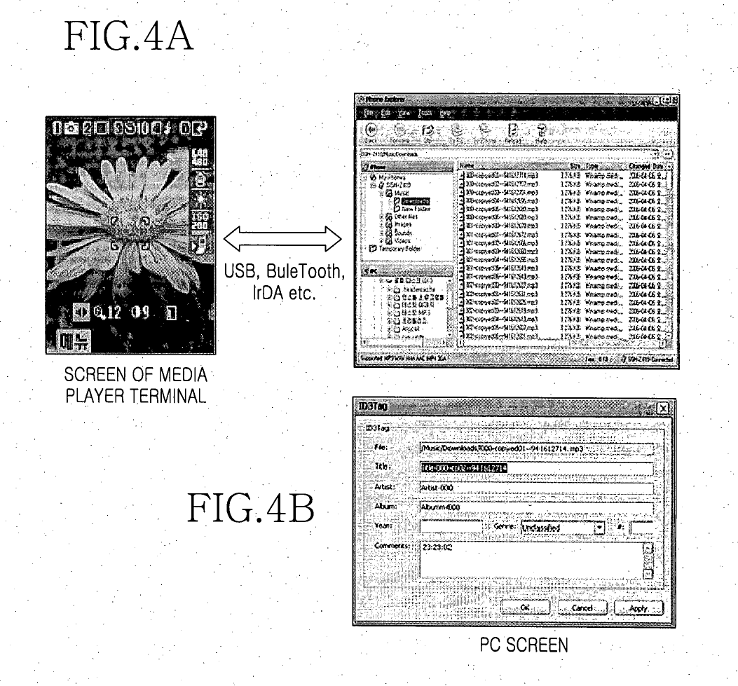

When the media file list and the ID-3 tag information of the media files are received from the media player terminal 200, the PC 210 displays the media file list on a screen at step 308, by which ID-3 tag information change can be made. An example of the screen may be displayed like part (a) of FIG. 4. When the user selects a specific file from the displayed screen, the PC 210 displays a pop-up window on the screen, by which an ID-3 tag of the specific file can be corrected. Here, the pop-up window is an edition window and should display all information corresponding to the ID-3 tag items based on the ID-3 tag information corresponding to the files. An example of the pop-up window may be displayed, as in part (b) of FIG. 4.

Then, in response to the user changing the ID-3 tag information of the selected file, the PC 210 changes the ID-3 tag information of the selected file at step 310. When the user confirms that the ID-3 tag information of the selected file is changed completely, the PC 210 transmits an ID-3 tag correction request message to the media player terminal 200, requesting the terminal 200 to correct the existing ID-3 tag information into the changed ID-3 tag information at step 312. The ID-3 tag correction message may be for example a “Get Mediafile_ID-3 tag” message for requesting the terminal to correct the ID-3 tag information of a specific file. The ID-3 tag correction request message may be composed as shown below in Table 6:

TABLE 6

| | | HdrName (Absolute path of a file to be |
|---|---|---|
| Command | Command Type | corrected, ID-3 tag contents) |
| CMD_PUF | fs/file_setid3tag | /Media/Music/CHANG Yun- |
| | | Jeong/Zzanzzara.mp3, <ID3Tag> |

In addition, an example of the ID-3 tag correction request message may be composed in Unicode as shown below in Table 7:

TABLE 7

“/Music/test.mp3”,0201009TestTitle02006Artist

As shown in Table 7 above, the ID-3 tag correction request message may be composed together with the ID-3 tag structure in Table 4 when the message including the media file list and the ID-3 tag information is composed. An example as reported in Table 7 above includes information indicating that the number of bodies is “02” and two of the ID-3 tag items are changed. Of the two changed items, the first one includes information indicating that the tag type is “01” and that the title is changed with reference to Table 3 above. The body length is “009,” and the body contents are “TestTitle.” In addition, the second one includes information indicating that the tag type is “02,” and the artist is changed with reference to Table 3 above. The body length is “006,” and the body contents are “artist.”

When the media player terminal 200 receives the ID-3 tag correction request message composed as in Table 6 above at step 312, the media player terminal 200 discerns the correction-requested ID-3 tag information included in the ID-3 tag correction request message, changes the currently-stored ID-3 tag information of a corresponding file into the received ID-3 tag information, and stores the result at step 314. When the media player terminal 200 stores the corrected ID-3 tag information of the corresponding file, which is correction-requested by the PC 210, it transmits a correction complete notification message to the PC 210 to notify that correction is successfully completed at step 316. The correction complete notification message may be composed as in Table 8 below:

TABLE 8

| Command Type | Body (Store result about request) |
|---|---|
| fs/file_setid3tag | <OK> or <FAIL> |

As described above, after a connection for communication is established between the media player terminal and the PC, the PC requests a media file list from the media player terminal, displays the media file list received from the media player list on the screen, corrects the ID-3 tag information of a file selected by the user, and then transmits the corrected ID-3 tag information to the media player terminal so that the media player terminal can change the ID-3 tag values of the selected file.

Consequently, in the case of correcting the ID-3 tag information of the media file, it is possible to transmit only the media file list and the ID-3 tag information, which are necessary for ID-3 tag information correction between the media player terminal and the PC. This confirms that all media file data are not necessarily transmitted.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A management system comprising:
a media player terminal storing the tag information of tag recorded a additional information of media files, the media player terminal generating, in response to a request message for a media file list, the media file list and transmitting the generated the media file list together with the tag information of the media files, and changing, in response to a correction request message, existing tag information of a corresponding one of the media files into requested tag information; and
an external device for sending, in response to an input for a tag correction, the media file list request message to the media player terminal, displaying, upon receiving the media file list, the received media file list, displaying, in response to a user selecting a corresponding media file to correct, the existing the tag information of the selected media file, and sending, in response to the user correcting the existing the tag information of the selected media file, the correction request message to the media player terminal to correct the existing the tag information of the selected media file.

2. The management system according to claim 1, wherein the media player terminal transmits a correction complete message to the external device to notify a result of changing the tag information of the selected media file.

3. The management system according to claim 1, wherein the media file list stores the media files, and includes at least one of the group consisting of names, sizes, types and date information of the media files.

4. The management system according to claim 1, wherein the media player terminal comprises:
a communication interface for enabling communication with the external device;
a key input unit for outputting a key signal corresponding to a key input;
a display unit for displaying input data;
a media file storage for storing the media file list, the media file list including at least one selected from the group consisting of names, sizes, types and date information of the media files and the tag information of the media files; and
a controller for generating, upon receiving the media file list request message, the media file list including the name of the media file stored in the media file storage, and transmitting the media file list and the tag information of the media file to the external device via the communication interface.

5. The management system according to claim 4, wherein the controller changes, upon receiving the correction request message via the communication interface, the existing tag information of the selected media file into the requested tag information included in the correction request message.

6. The management system according to claim 1, wherein the external device comprises:
a communication interface for enabling communication with the media player terminal;
a key input unit for outputting a key signal corresponding to a key input;
a display unit for displaying input data;
a controller for transmitting, in response to the user input for the tag correction, the media file request message to the media player terminal via the communication interface, displaying, upon receiving the media file list and the tag information of the media files via the communication interface, the media file list on the display unit, displaying, in response to the user selecting the corresponding media file to correct, the existing tag information of the selected media file, and transmitting, in response to the user correcting the existing tag information of the selected media file, the correction request message via the communication terminal to the media player terminal to correct the existing tag information of the selected media file.

7. A management method in a system which includes a media player terminal and an external device with a communication connection established therebetween, in which the media terminal stores tag information of media files, the method comprising the steps of:
at the external device, sending a media file list request message to the media player terminal in response to an input for a tag correction;
at the media player terminal, generating the media file list and transmitting the generated media file list together with the tag information of the media files in response to the media file list request message;
at the external device, displaying, upon receiving the media file list, the received media file list, displaying, in response to a user selecting at least one of the media files to correct, the existing tag information of the selected media file, and sending, in response to the user correcting the existing tag information of the selected media file, the correction request message to the media player terminal to correct the existing tag information of the selected media file into requested tag information; and
at the media player terminal, changing the existing tag information of the selected media file into the requested tag information in response to the correction request message.

8. The management method according to claim 7, further comprising: at the media player terminal, transmitting a correction complete message to the external device to indicate that the existing tag information is changed to the requested tag information.

9. The management method according to claim 7, wherein the media file list stores the media files, and includes at least one of the group consisting of names, sizes, types and date information of the media files.

10. The management method according to claim 7, wherein the media player terminal transmits the tag information of the media files together with the media file list to the external device in response to the media file list request message.
